(19) United States
(12) Patent Application Publication
(10) Pub. No.: US 2023/0135298 A1
(43) Pub. Date: May 4, 2023

(54) Apparatus for detecting a critical fall

(71) Applicant: Hilti Aktiengesellschaft, Schaan (LI)

(72) Inventors: Varnim GOYAL, Landsberg am Lech (DE); Simon MÜLLER, Bobingen (DE); Bernd ZIEGLER, Schwabmuenchen (DE)

(21) Appl. No.: 17/918,395

(22) PCT Filed: Apr. 20, 2021
(86) PCT No.: PCT/EP2021/060208

§ 371 Date: Oct. 12, 2022

(30) Foreign Application Priority Data
Apr. 28, 2020 (EP) 20171710.5

(51) Int. Cl. H01M 10/48; G01P 1/02; H01M 10/42; H01M 10/44; H02J 7/00

(52) U.S. Cl. CPC H01M 10/48; G01P 1/023; H01M 10/44; H01M 10/425; H02J 7/007188; B25F 5/00

(57) ABSTRACT

Apparatus for detecting a critical fall of a rechargeable battery and a rechargeable battery having an apparatus for detecting a critical fall, wherein the rechargeable battery contains a control device having a discharging device and also at least one energy storage device. The apparatus contains at least one sensor for detecting an acceleration value in a predetermined direction, control electronics that are configured to control at least one function of the rechargeable battery and also a fastening element for the at least one sensor, whereby the at least one sensor is mounted pivotably about a point of rotation in relation to the rechargeable battery and is kept essentially in a predetermined spatial position in relation to the rechargeable battery when the rechargeable battery rotates about at least one axis of rotation.

The present invention relates to an apparatus for detecting a critical fall of a rechargeable battery.

In addition, the present invention relates to a rechargeable battery having an apparatus for detecting a critical fall, wherein the rechargeable battery contains a control device having a discharging device and also at least one energy storage device.

### BACKGROUND

Modern power tools, such as hammer drills, saws, grinders or the like, and also rechargeable batteries, which can be connected to the power tools as an energy supply, are usually of a very robust design and show hardly any damage after a fall or mishandling.

### SUMMARY OF THE INVENTION

However, after a long fall from a particularly great height onto hard or unyielding ground, damage to the power tool and/or a rechargeable battery may well occur. This damage may not be directly visible or noticeable for a user of the power tool and/or the rechargeable battery. Damage to the power tool and/or the rechargeable battery that is not visible or not noticeable for a user may however represent a problem, since the functionality or mode of operation of the power tool and/or the rechargeable battery may no longer exist. For the user, however, it is not always easy to determine whether a fall or drop of one of the power tool and/or the rechargeable battery has caused damage and whether further use of the power tool and/or the rechargeable battery is still sufficiently safe.

Apparatuses for detecting a critical fall that are available on the market or are already known from the prior art often use acceleration sensors for measuring acceleration values, which are used as an indicator of a fall of the rechargeable battery. Depending on the measured acceleration value, a fall of the rechargeable battery may be assessed as critical or uncritical.

There are problems however with apparatuses having multiple acceleration sensors or multiple sensors that measure accelerations in different directions, since the amount of acceleration values that are measured and have to be processed often do not allow clear measurement results with reliable findings concerning the criticality of a fall of a rechargeable battery to be obtained.

An object of the present invention is to provide an apparatus for detecting a critical fall of a rechargeable battery and a rechargeable battery having an apparatus for detecting a critical fall with which the aforementioned problem can be solved and a critical fall or drop can be clearly detected.

The present invention provides an apparatus for detecting a critical fall of a rechargeable battery.

According to the invention, the apparatus contains at least one sensor for detecting an acceleration value in a predetermined direction, control electronics that are configured to control at least one function of the rechargeable battery and also a fastening element for the at least one sensor, whereby the at least one sensor is mounted pivotably about a point of rotation in relation to the rechargeable battery and is kept essentially in a predetermined spatial position in relation to the rechargeable battery when the rechargeable battery rotates about at least one axis of rotation. It can be ensured in this way that the sensor always detects acceleration values in a single direction. The amount of data and values detected can consequently be reduced and an evaluation of the criticality of a fall made easier.

A fall from a critical (i.e. great) height leads to a sudden and relatively strong deceleration of the falling object on the underlying surface that the apparatus hits. This deceleration on the underlying surface corresponds to a strong acceleration of the falling apparatus. The longer the fall, the greater the acceleration of the apparatus.

According to an advantageous embodiment of the present invention, it may be possible that the control electronics are configured to send at least one signal to the control electronics when a predetermined acceleration threshold value is detected by the at least one sensor. The signal sent can achieve the effect that the rechargeable battery is disabled and no electrical energy can be delivered any longer. Furthermore, the signal sent may have the effect that renewed charging of the rechargeable battery with electrical energy is no longer possible. For this purpose, the signal sent by the control electronics goes to a control device of the rechargeable battery.

In addition, the object is achieved by a rechargeable battery having an apparatus for detecting a critical fall, wherein the rechargeable battery contains a control device having a discharging device and also at least one energy storage device.

According to the invention, it is provided that the apparatus for detecting a critical fall contains at least one sensor for detecting an acceleration value in a predetermined direction, control electronics that are configured to control at least one function of the rechargeable battery and also a fastening element for the at least one sensor, wherein the fastening element is configured such that the at least one sensor is mounted pivotably about a point of rotation in relation to the rechargeable battery and is kept essentially in a predetermined spatial position in relation to the rechargeable battery when the rechargeable battery rotates about at least one axis of rotation.

The sensor may be an acceleration sensor, gyro sensor or the like, with which an acceleration or acceleration values can be detected. The sensor may in this case be configured such that only acceleration values in a single direction are detected. It is also possible however that the sensor is configured to detect acceleration values in three direction axes orthogonal to one another.

According to one advantageous embodiment of the present invention, it may be possible that the at least one energy storage device is at least partially discharged by the discharging device if a predetermined acceleration threshold value is detected by the at least one sensor. As a result, the safety when handling a possibly damaged rechargeable battery as a result of a critical fall can be increased.

The discharging apparatus may be formed by at least one capacitor, at least one transistor and/or at least one electrical resistor.

According to a further advantageous embodiment of the present invention, it may be possible that the control electronics and/or control device is/are configured such that charging of the at least one energy storage device with electrical energy is prevented if a predetermined acceleration threshold value is detected by the at least one sensor. As a result, a potential risk caused by the charging of a possibly damaged rechargeable battery with electrical energy can be prevented.

### BRIEF DESCRIPTION OF THE DRAWINGS

Further advantages will become apparent from the following description of the figures. Various exemplary embodiments of the present invention are illustrated in the figures. The figures, the description and the claims contain numerous features in combination. A person skilled in the art will expediently also consider the features individually and combine them into useful further combinations.

In the figures:

FIG. 1 shows a perspective view of a rechargeable battery having an apparatus for detecting a critical fall of a rechargeable battery;

FIG. 2 shows a perspective view of the apparatus for detecting a critical fall of a rechargeable battery in a first spatial position or alignment connected to a control device of the rechargeable battery;

FIG. 3 shows a perspective view of the apparatus for detecting a critical fall of a rechargeable battery in a second spatial position or alignment connected to the control device of the rechargeable battery; and

FIG. 4 shows a view of a detail of a sensor with a fastening element for the sensor.

### DETAILED DESCRIPTION

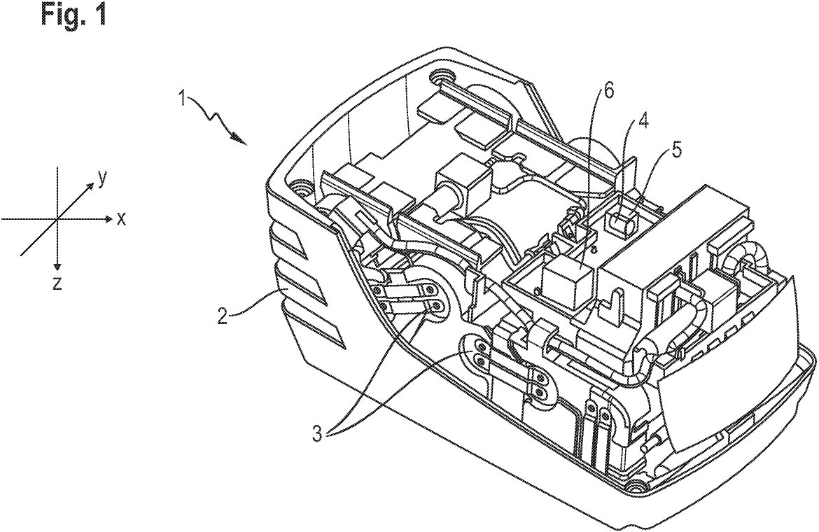

FIG. 1 depicts a rechargeable battery 1. The rechargeable battery 1 can, for example, be detachably connected to a power tool in order to supply the power tool with electrical energy. The power tool is not illustrated in the figures. The power tool may be a drill, a saw, a grinder or the like.

The rechargeable battery 1 essentially contains a housing 2, a number of energy storage cells 3, a discharging device 4 and a control device 5. The energy storage cells 3 are used for receiving, storing and indicating electrical energy or voltage. The discharging device 4 is configured in the form of a powerful capacitor and is used for the controlled discharge of the energy storage cells 3, i.e. the removal of the electrical energy from the energy storage cells 3. The control device 5 is used for controlling and regulating various functions of the individual components of the rechargeable battery 1 or the entire rechargeable battery 1.

The energy storage cells 3 can also be referred to as rechargeable battery cells and are based on lithium-ion technology.

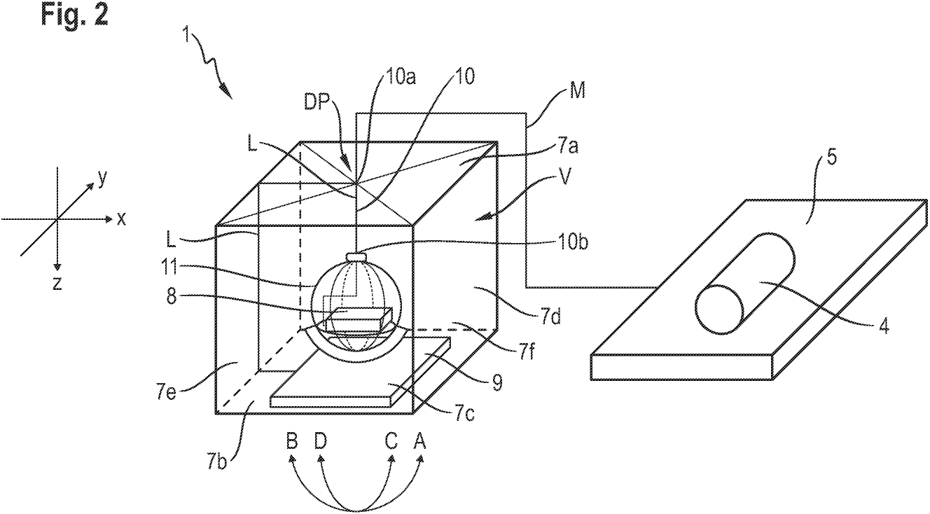

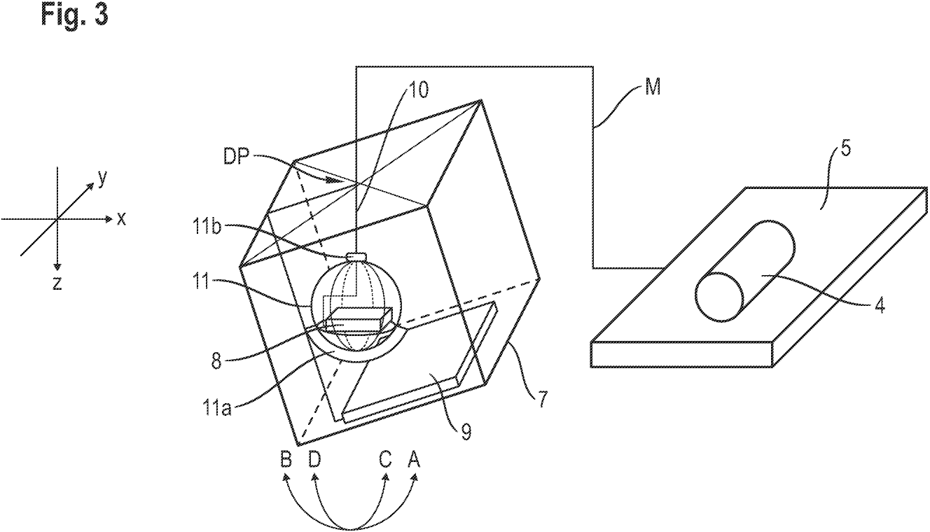

Furthermore, the rechargeable battery 1 contains an apparatus 6 for detecting a critical fall. As indicated in FIGS. 2 and 3, the apparatus 6 for detecting a critical fall is connected to the control device 5 of the rechargeable battery 1. The control device 5 is connected to the energy storage cells 3 such that electrical energy can pass from the energy storage cells 3 to the control device 5. The connection to the control device 5 supplies the apparatus 6 with voltage or electrical energy from the energy storage cells 3. Furthermore, data and information can be exchanged between the apparatus 6 and the control device 5 of the rechargeable battery 1 in the form of signals.

FIG. 2 depicts the apparatus 6 for detecting a critical fall in an exemplary embodiment that is given by way of example.

The apparatus 6 in this case essentially contains a frame 7, a sensor 8, control electronics 9, a fastening element 10 and a carrier device 11.

The frame 7 has essentially an upper side 7a, an underside 7b, a front side 7c, a rear side 7d, a left side wall 7e and a right side wall 7f. As a result, the frame 7 forms an interior space or an interior volume V.

The fastening element 10 takes the form of a rod with a first end 10a and a second end 10b.

The sensor 8 is configured in the form of an acceleration sensor. The acceleration sensor is configured to detect accelerations in the form of acceleration values in the direction z.

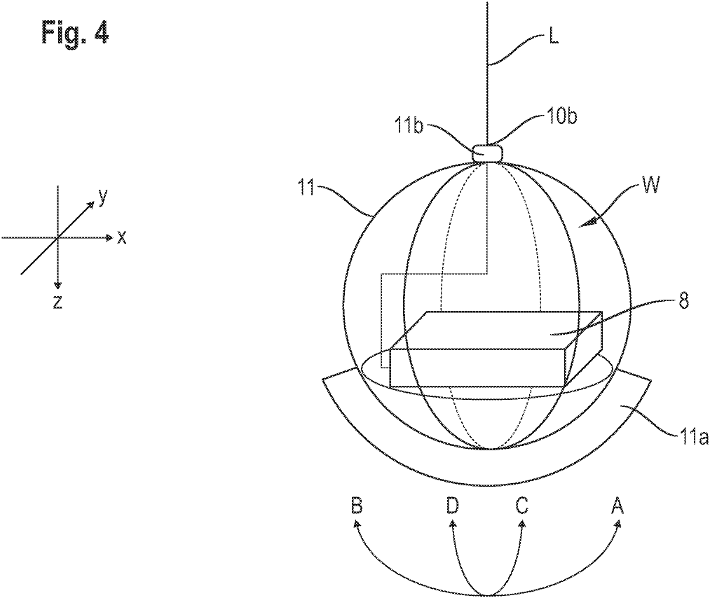

The carrier device 11 is configured in the form of a hollow sphere having an interior space or an interior volume W. As shown in FIG. 4, the sensor 8 is securely fastened in the interior space W of the carrier device 11 configured as a sphere. As can likewise be seen in FIG. 4, a weight element 11a is fastened on an underside of the carrier device 11 configured as a sphere. The additional weight element 11a is used for increasing the inertia of the carrier device 11. In addition, an elastic coupling element 11b is positioned between the second end 10b of the fastening element 10 and the carrier device 11. The coupling element 11b is used to compensate for relative movements between the second end 10b of the fastening element 10 and the carrier device 11.

The control electronics 9 are configured in the form of a flat printed circuit board and are fastened on the underside 7b in the interior space V of the frame 7. The control electronics 9 are used inter alia for storing and processing the acceleration values detected by the sensor and for emitting signals derived from the acceleration values and other data.

As can likewise be seen in FIGS. 2, 3 and 4, a line L leads from the sensor 8 to the control electronics 9, whereby the acceleration values detected by the sensor 8 are sent to the control electronics 9. The fact that the control electronics 9 and the control device 5 of the rechargeable battery 1 are connected to one another by way of lines M means that data and information can likewise be exchanged between the control electronics 9 and the control device 5.

The fastening element 10 is fastened by the first end 10a on the upper side 7a of the frame 7 in the interior of the frame 7 or within the interior volume V of the frame 7. The carrier device 11 configured as a sphere is fastened on the second or free end 10b of the fastening element 10. The first end 10a of the fastening element 10 is movably fastened to the upper side 7a of the frame 7 such that the carrier device 11 can freely oscillate as a pendulum in the interior volume V of the frame 7 by means of the fastening element 10. The first end 10a of the fastening element 10 is therefore used as a point of rotation DP for sensor 8. The extents or side lengths of the frame 7 and the length of the fastening element 10 are chosen such that, when there is rotation of the frame 7 in the direction of rotation A, B, C or D, the carrier device 11 configured as a sphere does not reach as far as a side wall of the frame 7.

As described above, the sensor 8 in the carrier device 11 is mounted by the fastening element 10 in the frame 7 in a freely oscillating manner as a pendulum such that rotating or pivoting of the frame 7 in the direction of rotation A, B, C or D does not lead to any change in the spatial position of the sensor 8. As shown in FIG. 3, the spatial position or alignment of the sensor 8 remains stationary even when the rechargeable battery or the frame 7 is rotating. As a result, it is possible for the sensor 8 always to detect acceleration values in one and the same direction z.

In the event that the rechargeable battery 1 falls and during freefall rotates about one or more of its three axes x, y or z, the sensor 8 suspended as a pendulum remains consistently aligned in the interior of the apparatus 6 and always detects the acceleration values in the direction z.

On the basis of the acceleration values in the direction z detected by the sensor 8, it can be assessed by means of the control electronics 9 whether a predetermined threshold value for the acceleration has been reached because of the fall. For this purpose, threshold values for the acceleration are stored in a memory of the control electronics 9. The memory of the control electronics 9 is not shown in the figures.

When a threshold value for the acceleration in the direction z has been reached on account of a fall of the rechargeable battery 1, it can be assumed that, because of the relatively high acceleration, the impact of the rechargeable battery 1 on the ground constitutes a critical fall. In the case of a critical fall, damage to the rechargeable battery 1 and its components is not ruled out.

In response, the control electronics 9 send a corresponding signal to the control device 5.

The control device 9 then causes the controlled discharge of the energy storage cells 3 by means of the discharging device 4.

In addition, it is also possible that, by emitting a signal, the control device 5 causes that renewed charging of the energy storage cells 3 with electrical energy is blocked if the rechargeable battery 1 is connected to a charging apparatus.

The charging apparatus is not shown in the figures.

LIST OF REFERENCE SIGNS

| | |
|---|---|
| 1 | Rechargeable battery |
| 2 | Housing for the rechargeable battery |
| 3 | Energy storage cells |
| 4 | Discharging apparatus |
| 5 | Control device |
| 6 | Apparatus for detecting a critical fall of a rechargeable battery |
| 7 | Frame |
| 7 a | Upper side of the frame |
| 7 b | Underside of the frame |
| 7 c | Front side of the frame |
| 7 d | Rear side of the frame |
| 7 e | Left side wall of the frame |
| 7 f | Right side wall of the frame |
| 8 | Sensor |
| 9 | Control electronics |
| 10 | Fastening element |
| 10 a | First end of the fastening element |
| 10 b | Second end of the fastening element |
| 11 | Carrier device |
| 11 a | Weight element |
| 11 b | Coupling element |
| DP | Point of rotation |
| V | Interior volume of the frame |
| W | Interior volume of the carrier device |

What is claimed is:

1-5. (canceled)

6. An apparatus for detecting a critical fall of a rechargeable battery, the apparatus comprising:
at least one sensor for detecting an acceleration value in a predetermined direction;
control electronics configured to control at least one function of the rechargeable battery; and
a fastener for the at least one sensor, the at least one sensor being mounted pivotably about a point of rotation in relation to the rechargeable battery and kept in a predetermined spatial position in relation to the rechargeable battery when the rechargeable battery rotates about at least one axis of rotation.

7. The apparatus as recited in claim 6 wherein the control electronics are configured to send at least one signal to the control electronics when a predetermined acceleration threshold value is detected by the at least one sensor.

8. A rechargeable battery comprising:
an apparatus for detecting a critical fall;
a controller having a discharging device; and
at least one energy storage;
the apparatus including at least one sensor for detecting an acceleration value in a predetermined direction, control electronics configured to control at least one function of the rechargeable battery and a fastener for the at least one sensor, the fastener configured such that the at least one sensor is mounted pivotably about a point of rotation in relation to the rechargeable battery and is kept in a predetermined spatial position in relation to the rechargeable battery when the rechargeable battery rotates about at least one axis of rotation.

9. The rechargeable battery as recited in claim 8 wherein the at least one energy storage is at least partially discharged by the discharging device if a predetermined acceleration threshold value is detected by the at least one sensor.

10. The rechargeable battery as recited in claim 8 wherein the control electronics or the controller is configured such that charging of the at least one energy storage with electrical energy is prevented if a predetermined acceleration threshold value is detected by the at least one sensor.
